(19) United States
(12) Patent Application Publication
(10) Pub. No.: US 2021/0321498 A1
(43) Pub. Date: Oct. 14, 2021

(54) RADIATION MODULE AND MICROWAVE OVEN COMPRISING SAME

(71) Applicant: SP&PARTNERS LTD., Seoul (KR)

(72) Inventor: Soo Yong PARK, Seoul (KR)

(21) Appl. No.: 17/260,114

(22) PCT Filed: Jul. 10, 2019
(86) PCT No.: PCT/KR2019/008457

§ 371 Date: Jan. 13, 2021

(30) Foreign Application Priority Data
Jul. 16, 2018 (KR) 10-2018-0082307

(51) Int. Cl. H05B 6/72; H05B 6/70; H01Q 13/10

(52) U.S. Cl. CPC H05B 6/72; H01Q 13/10; H05B 6/707

(57) ABSTRACT

Proposed are a radiation module, which can uniformly radiate microwaves from an upper part of a cooking chamber and can offset reflected waves in waveguides when microwaves are radiated from the upper part of the cooking chamber, and a microwave range having the same. The radiation module includes: first and second waveguides disposed at an upper part of a cooking chamber to form parallel routes to guide microwaves of a magnetron; and a plurality of paired slot antennas arranged on bottom surfaces of the first and second waveguides in a progress direction of the microwaves, wherein each paired slot antenna includes two slot antennas, the two slot antennas have a first interval distance relative to the progress direction of the microwaves and are arranged to intercross each other in the opposite directions to each other based on central lines of the waveguides.

### TECHNICAL FIELD

The present invention relates to a microwave range, and more particularly, to a radiation module which uniformly radiates microwaves in an upper portion of a cooking chamber, and a microwave range having the same.

### BACKGROUND ART

A microwave range has a structure to radiate microwaves into a cooking chamber in order to cook food.

A general microwave range has a magnetron for generating microwaves to an electric chamber of the side of the cooking chamber in order to radiate microwaves to the cooking chamber through the side wall of the cooking chamber. The side radiation type microwave range needs to rotate food in order to uniformly heat food in the cooking chamber since radiating microwaves through the side wall of the cooking chamber. Therefore, the side radiation type microwave range requires parts for rotating food, such as a turn table, rollers, and a motor mounted in the cooking chamber and in a lower space.

Meanwhile, upper side radiation type microwave ranges for radiating microwaves to the cooking chamber from an upper part of the cooking chamber have been developed, and such upper side radiation type microwave ranges require technology to uniformly radiate microwaves from the upper part of the cooking chamber into the cooking chamber.

### PRIOR ART LITERATURE

Korean Patent No. 10-1781477 (granted on Sep. 19, 2017, entitled “Microwave range and radiation module thereof”)

### DISCLOSURE

### Technical Problem

Accordingly, the present invention has been made in an effort to solve the above-mentioned problems occurring in the prior arts, and it is an object of the present invention to provide a radiation module, which can uniformly radiate microwaves from an upper part of a cooking chamber, and a microwave range having the same.

It is another object of the present invention to provide a radiation module, which can offset reflected waves in waveguides when microwaves are radiated from the upper part of the cooking chamber, and a microwave range having the same.

It is a further object of the present invention to provide a radiation module, which can improve radiation efficiency of microwaves radiated into the cooking chamber from the wave guide by reducing coupling between two neighboring slot antennas formed in a pair, and a microwave range having the same.

### Technical Solution

To achieve the above objects, the present invention provides a radiation module including: first and second waveguides disposed at an upper part of a cooking chamber to form parallel routes to guide microwaves of a magnetron; and a plurality of paired slot antennas arranged on bottom surfaces of the first and second waveguides in a progress direction of the microwaves, wherein each paired slot antenna includes two slot antennas, the two slot antennas have a first interval distance relative to the progress direction of the microwaves and are arranged to intercross each other in the opposite directions to each other based on central lines of the waveguides, and the first interval distance is a quarter of the wavelength of the microwaves in the waveguides.

In another aspect of the present invention, to achieve the above objects, the present invention provides a microwave range including: a cooking chamber; a magnetron for radiating microwaves through antennas; and a radiation module for guiding the microwaves radiated from the antennas to an upper part of the cooking chamber, wherein the radiation module includes: first and second waveguides disposed at an upper part of a cooking chamber to form parallel routes to guide microwaves of a magnetron; and a plurality of paired slot antennas arranged on bottom surfaces of the first and second waveguides in a progress direction of the microwaves. Each paired slot antenna includes two slot antennas, the two slot antennas have a first interval distance relative to the progress direction of the microwaves and are arranged to intercross each other in the opposite directions to each other based on central lines of the waveguides, and the first interval distance is a quarter of the wavelength of the microwaves in the waveguides.

### Advantageous Effects

The present invention can cook food uniformly since the paired slot antennas are arranged in the progress direction of microwaves of the waveguides and a pair of the waveguides are formed to be horizontally parallel so that the microwaves can be radiated uniformly in the cooking chamber.

Moreover, the present invention can offset reflected waves in the waveguides by the two slot antennas since the two slot antennas of each paired slot antenna intercross each other in the opposite directions based on the central lines of the waveguides and are arranged in such a way that a distance between the centers of the two slot antennas becomes a quarter of the wavelength of the microwaves in the waveguides.

Furthermore, the two slot antennas of each paired slot antenna are formed in the opposite direction based on the central lines of the waveguides not to face each other. Therefore, the present invention can minimize coupling between the two slot antennas and guarantee that the two slot antennas act independently. As a result, radiation efficiency of microwaves is improved. Additionally, the present invention can radiate spatially uniform microwaves since microwaves are radiated into the cooking chamber by a plurality of the paired slot antennas, and can provide temporally uniform heating effect to food due to a phase difference of the microwaves radiated from the two slot antennas and progress effect of the microwaves in the waveguides.

### DESCRIPTION OF DRAWINGS

FIG. 1 is a perspective view showing a microwave range according to an embodiment of the present invention.

FIG. 2 is a plan view showing a radiation module adopted in an upper part of a cooking chamber of FIG. 1.

FIG. 3 is a sectional view showing the radiation module of FIG. 2.

FIG. 4 is a view showing paired slot antennas arranged on waveguides of FIG. 2.

FIG. 5 is a view showing a detailed structure of the slot antennas of FIG. 4.

FIG. 6 is a graph showing radiation efficiency of the radiation module according to an embodiment of the present invention.

FIG. 7 is a view showing an example of an electric force line by radiation of microwaves.

### MODE FOR INVENTION

Hereinafter, reference will be now made in detail to the preferred embodiments of the present invention with reference to the attached drawings. It will be understood that words or terms used in the specification and claims shall not be interpreted as the meaning defined in commonly used dictionaries. It will be further understood that the words or terms should be interpreted as having a meaning that is consistent with their meaning in the context of the relevant art and the technical idea of the invention.

The description of the preferred embodiments is to be construed as exemplary only and does not describe every possible instance of the invention. Therefore, it should be understood that various changes may be made and equivalents may be substituted for various elements of the invention.

This embodiment discloses a radiation module, which can uniformly radiate microwaves with high efficiency from an upper part of a cooking chamber, and can offset reflected waves in waveguides, and a microwave range having the same.

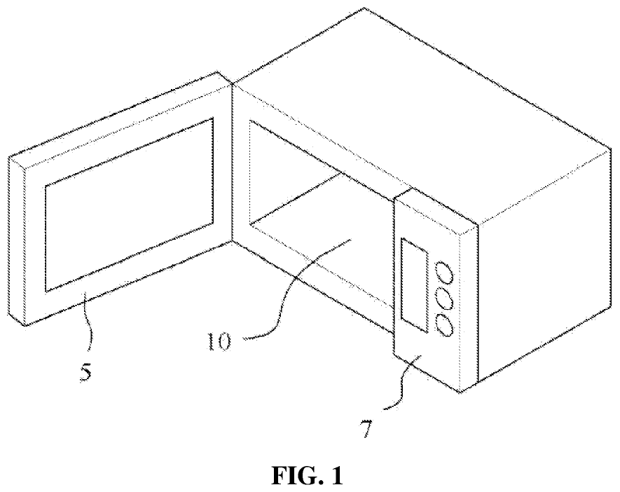

FIG. 1 is a perspective view showing a microwave range according to an embodiment of the present invention.

Referring to FIG. 1, the microwave range includes a door 5, and a control panel 7 displaying operation buttons and operation states. Moreover, the microwave range includes a cooking chamber 10 openable by the door 5, and the cooking chamber 10 has an inner space for cooking received food.

The microwave range is divided into the cooking chamber 10 and an electric chamber, and the electric chamber may be formed in a space at a side of the cooking chamber 10, for instance, in a rear space of the control panel 7. The electric chamber is a space covered by a case (not shown) like the cooking chamber 10, and is used to mount a magnetron 20 which will be described later, a part of a radiation module 30 which will be described later, a printed circuit board of the control panel 7, and electric wires therein.

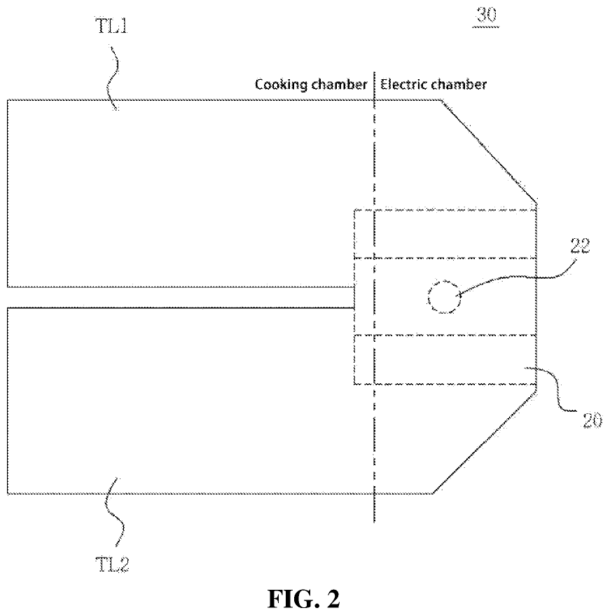

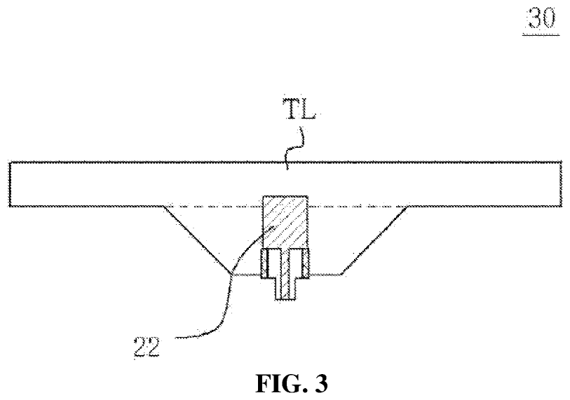

FIG. 2 is a plan view showing the radiation module 30 adopted in the upper part of a cooking chamber of FIG. 1, and FIG. 3 is a sectional view showing the radiation module of FIG. 2.

Referring to FIGS. 2 and 3, the radiation module 30 includes first and second waveguides TL1 and TL2, and the magnetron 20.

The magnetron 20 generates microwaves of a predetermined frequency, and radiates microwaves in directions of the first and second waveguides TL1 and TL2 through antennas 22.

The first and second waveguides TL1 and TL2 are disposed at the upper part of the cooking chamber 10 and form parallel routes to guide the microwaves of the magnetron 20.

In more detail, the first and second waveguides TL1 and TL2 are connected with each other integrally at an area where the magnetron 20 is located, and are formed in a fork shape that they split from the location of the magnetron 20 and extend in the same direction, namely, horizontally toward the upper part of the cooking chamber 10 to be spaced apart from each other so as to form symmetrical routes.

That is, the first and second waveguides TL1 and TL2 induce the microwaves radiated from the antennas 22 of the magnetron 20 to the upper part of the cooking chamber 10 to guide the microwaves parallel to each other.

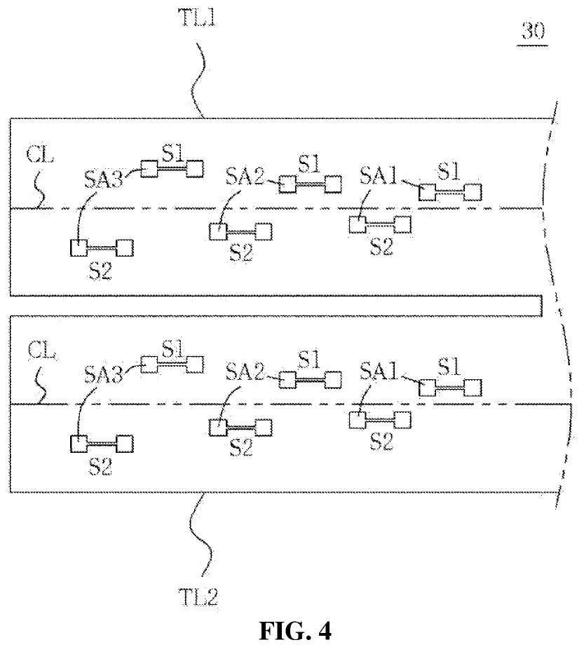

Each of the first and second waveguides TL1 and TL2 includes a plurality of paired slot antennas SA1, SA2 and SA3 (in FIG. 4) arranged on the bottom surface in a progress direction of the microwaves. The first and second waveguides TL1 and TL2 radiate microwaves into the cooking chamber 10 of a lower part through the paired slot antennas SA1, SA2 and SA3 while progressing the microwaves.

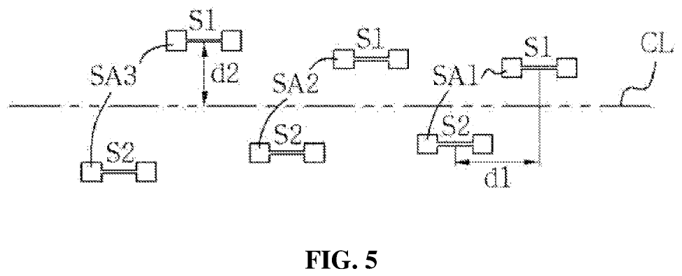

FIG. 4 is a view showing the paired slot antennas (SA1, SA2 and SA3 arranged on first and second waveguides TL1 and TL2, and FIG. 5 is a view showing an interval between the slot antennas S1 and S2 of the paired slot antennas SA1, SA2 and SA3.

Referring to FIGS. 4 and 5, the first and second waveguides TL1 and TL2 are horizontally spaced apart from each other in two directions based on the magnetron 20, have the same structure, and are formed to guide the microwaves in parallel to each other after inducing the microwaves to the upper part of the cooking chamber 10.

Moreover, the paired slot antennas SA1, SA2 and SA3 (in FIG. 4) are formed on the bottom surfaces of the first and second waveguides TL1 and TL2 to have the same pattern. In this embodiment, the paired slot antennas are arranged to maximize radiation efficiency into the cooking chamber and minimize reflected waves into the waveguides.

Each of the paired slot antennas SA1, SA2 and SA3 includes a pair of slot antennas S1 and S2, and a pair of the slot antennas S1 and S2 are formed in such a way that a first interval distance d1 between the centers of long axes of the slot antennas S1 and S2 becomes a quarter of the wavelength of the microwaves of the waveguides.

Here, it is understandable that the long axes of the slot antennas S1 and S2 are axes of the longitudinal direction relative to a penetrated space and are formed at the center of the width of each of the paired slot antennas S1 and S2.

The slot antennas S1 and S2 include a pair of square through holes and a connection hole for forming a through hole. The connection hole connects the square through holes with the same area formed at both ends. The connection hole is narrower than the square through holes. Resonance capacitances of the first and second slot antennas S1 and S2 are adjusted by the width of the connection hole. That is, the resonance capacitances are increased when the width of the connection hole gets narrower, and are decreased when the width of the connection hole gets wider. The slot antennas S1 and S2 are formed to have a dumbbell shape that the square through holes are formed to be symmetric based on the connection hole.

The slot antennas S1 and S2 formed on the paired slot antennas SA1, SA2 and SA3 are arranged in such a way that the long axes are parallel to central lines CL of the waveguides.

The slot antennas S1 and S2 are arranged to intercross each other based on the central lines CL of the first and second waveguides TL1 and TL2. In more detail, the slot antennas S1 and S2 are formed not to face each other based on the central lines CL and are formed to have an interval distance between the centers of the long axes, which is a quarter of the wavelength of the microwaves of the waveguides.

Furthermore, the two slot antennas S1 and S2 of each of the paired slot antennas SA1, SA2 and SA3 may be arranged to have the same pattern. In detail, the slot antennas S1 and S2 of the paired slot antennas SA1, SA2 and SA3 may be formed to have the same cross pattern and shape.

In more detail, the first and second waveguides TL1 and TL2 are symmetrical to each other to be parallel to each other, so that microwaves radiated from the magnetron 20 progress in the same direction from the upper part of the cooking chamber. The paired slot antennas SA1, SA2 and SA3 of the first and second waveguides TL1 and TL2 have the same arrangement structure, and radiate microwaves to the cooking chamber 10 of the lower part. Each of the paired slot antennas SA1, SA2 and SA3 includes two slot antennas S1 and S2 formed to have the same pattern and shape.

The paired slot antennas neighboring each other are formed to be spaced apart from each other as long as one half of the wavelength of the microwaves in the waveguides in the progress direction of the microwaves. Therefore, phases of the microwaves radiated between the neighboring paired slot antennas are opposite to each other.

In the meantime, in this embodiment, three pairs of the paired slot antennas SA1, SA2 and SA3 are formed on the bottom surfaces of the first and second waveguides TL1 and TL2, but the present invention is not limited to the above. The number of the pairs of slot antennas may be determined according to the area of the cooking chamber 10.

Output of the microwaves is reduced as progressing along the waveguides. If output reduction of the microwaves is not offset, the microwaves are difficult to be uniformly radiated by the pairs of slot antennas.

As described above, in order to offset the microwaves reduced as progressing along the waveguides, the later the arrival order of the microwaves is by the unit of the paired slot antennas or by the unit of the slot antenna arranged on the first and second waveguides TL1 and TL2, the longer a second interval distance d2 between the slot antennas and the central lines CL is.

As a first example, by the unit of the paired slot antennas, the later the arrival order of the microwaves is, the longer the second interval distance d2 between the slot antennas and the central lines CL of the waveguides is.

In this instance, according to the arrival order of the microwaves, the second interval distance d2 between the slot antennas S1 and S2 of the third pair of the paired slot antennas SA3 and the central lines CL is longer than that of the slot antennas S1 and S2 of the second pair of the paired slot antennas SA2, and the second interval distance d2 between the slot antennas S1 and S2 of the second pair of the paired slot antennas SA2 and the central lines CL is longer than that of the slot antennas S1 and S2 of the first pair of the paired slot antennas SAL

In this instance, the slot antennas S1 and S2 of the first pair of the paired slot antennas SA1 may be formed to have the same second interval distance d2 between the slot antennas S1 and S2 and the central lines CL or formed such that the second interval distance d2 of the slot antennas S1 and S2 at which the microwaves arrive later is longer. Moreover, the slot antennas S1 and S2 of the second and third pairs of the paired slot antennas SA2 and SA3 may have the same pattern as the first pair of the paired slot antennas SAL

As a second example, by the unit of the slot antennas, the second interval distances d2 of all slot antennas relative to the central lines CL of the waveguides may be formed to be as long as the arrival order of the microwaves is late.

In this instance, according to the arrival order of the microwaves, the slot antenna S1 of the first pair of the paired slot antennas SA1 of which the arrival order of microwaves is the fastest is the shortest in the second interval distance d2 relative to the central lines CL. Furthermore, the second interval distance d2 between the slot antenna and the central lines CL of the waveguides gets gradually longer in order of the slot antenna S2 of the first pair of the paired slot antennas SA1, the slot antennas S1 and S2 of the second pair of the paired slot antennas SA2, and the slot antenna S1 of the third pair of the paired slot antennas SA3. The slot antennas S2 of the third pair of the paired slot antennas SA3 are the longest in the second interval distance d2 relative to the central lines CL of the waveguides.

In the above case, the second interval distance d2 between the slot antennas S2 of the first to third pairs of the paired slot antennas SA1 to SA3 and the central lines CL of the waveguides is longer than that between the slot antennas S1 of the first to third pairs of the paired slot antennas SA1 to SA3 and the central lines CL of the waveguides.

Additionally, in order to offset reduction of the microwaves as progressing along the waveguides, the first and second waveguides TL1 and TL2 may be designed to have an inclined surface which gets gradually lower from the magnetron 20 to a linear end portion. The lower the waveguides are, the higher conductance is.

That is, the first and second waveguides TL1 and TL2 can offset output reduction according to progress of the microwaves by conductance getting higher according to a change in height.

In this embodiment, the conductance by the slot antennas for outputting microwaves can be adjusted according to the change in the second interval distance d2 between each paired slot antennas or each slot antenna and the central lines CL of the waveguides and the change in height of the waveguides by location of the slot antennas.

As a result, microwaves can be uniformly radiated to the cooking chamber 10 by the paired slot antennas SA1, SA2 and SA3 formed on the first and second waveguides TL1 and TL2.

In addition, the microwaves radiated from the slot antennas S1 and S2 of each paired slot antennas of the first and second waveguides TL1 and TL2 have a phase difference of a quarter cycle relative to one another. Because the microwaves having the phase difference of the one quarter cycle are radiated along with the progress of the microwaves in the waveguides, the microwaves radiated in the cooking chamber 10 have a spatial distribution with a uniform temporal average.

In the meantime, the slot antenna S1 and the slot antenna S2 of the paired slot antennas are arranged to intercross each other based on the central lines CL of the waveguides. Such an arrangement remarkably increases a distance between the two slot antennas S1 and S2 of the paired slot antennas and minimizes coupling between the two slot antennas S1 and S2. This prevents two slot antennas S1 and S2 from forming two new coupled modes with different frequencies.

Therefore, the slot antennas S1 and S2 act independently, and two reflected waves generated from the slot antennas S1 and S2 apply destructive interference to each other in the waveguides so as to accomplish the intended object to offset reflected waves.

If the microwaves radiated in the cooking chamber progress in the same direction as the waveguides and have the same wavelength as the waveguides, the two microwaves radiated from the slot antennas S1 and S2 arranged to intercross each other based on the central lines CL of the waveguides apply destructive interference to each other, and finally, there is little radiation of microwaves.

However, the cooking chamber is still larger than the space of the waveguides. Therefore, the microwaves radiated in the cooking chamber have the wavelength in a free space, which is different from the waveguides, and have various three-dimensional progress directions. Therefore, the microwaves in the cooking chamber 10 are synthesized in a different way from the waveguides.

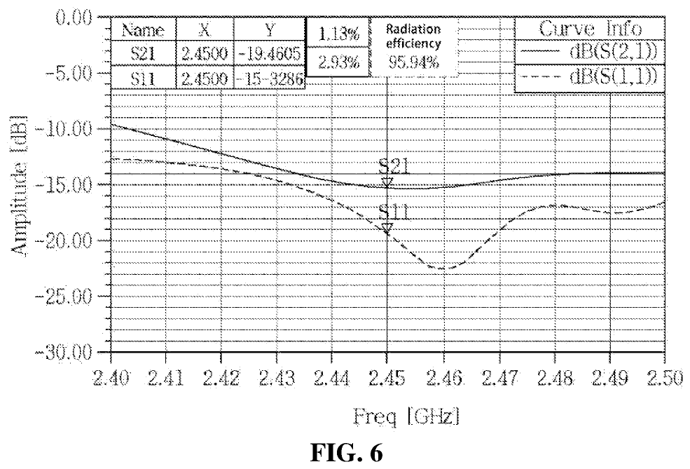

In fact, as you can see from a S-parameter computer simulation data of FIG. 6, the reflected waves may be designed to be limited within several percentages and to have radiation of almost 95%.

Moreover, if a temporal change of an electric field distribution in the cooking chamber 10 is calculated through the computer simulation, it is confirmed that the microwaves radiated from the paired slot antennas SA1, SA2 and SA3 progress in the same direction as the waveguides.

Furthermore, the electric field of the microwaves radiated from the paired slot antennas SA1 to SA3 arranged along the waveguides has coherency to each other so as to form linear polarized beam waves which are perpendicular to the waveguides.

Meanwhile, because the neighboring paired slot antennas are spaced apart from each other as far as a half of the wavelength of the microwaves in the waveguides in the progress direction of the microwaves, microwaves with opposite phase are radiated to the cooking chamber 10.

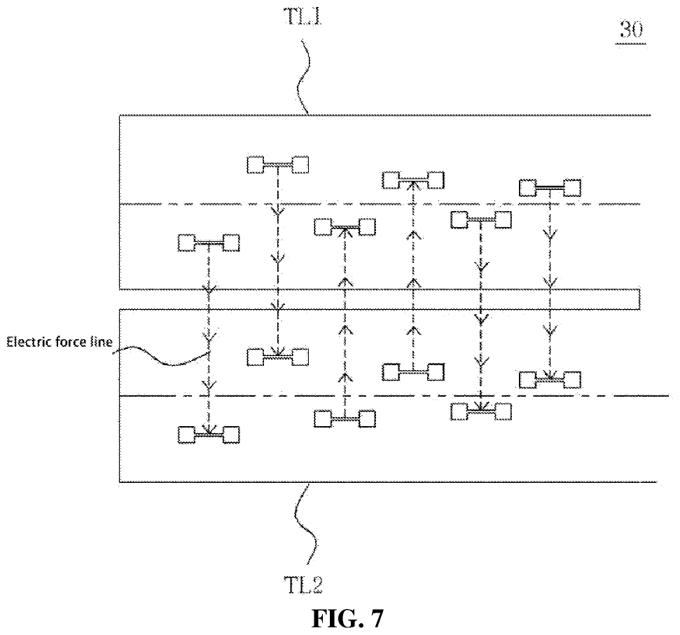

That is, as shown in FIG. 7, the neighboring paired slot antennas, for instance, the first pair of the paired slot antennas SA1 and the second pair of the paired slot antennas SA2, which are opposite in the direction of the electric field radiate linear polarized beams perpendicular to the waveguides and have a strong tendency of forming electric force lines of the opposite directions by turns. In this instance, in case of the linear polarized beams of the opposite directions, because a valley where the electric field becomes zero is formed in a space between the linear polarized beams, food in the cooking chamber 10 may not be heated uniformly. However, even in the above case, a great time standardization may occur due to the effect of the above-mentioned progress waves so as to obtain improved uniform heating effect.

Therefore, the property separation sensor according to the present invention can minimize reflected waves to nearly several percent under a condition that radiation efficiency is realized to more than 95% using the paired slot antennas having the slot antennas arranged to intercross each other on the basis of the central lines CL of the waveguides, and is excellent at uniform heating effect due to the time standardization effect by the progress waves.

Additionally, a pair of the slot antennas S1 and S2 are spaced apart from each other as long as the distance corresponding to a quarter of the wavelength of the microwaves in the waveguides, and radiate microwaves to the cooking chamber 10 to have a phase difference of a quarter cycle. Therefore, the present invention can provide temporal uniformalization relative to heating effect since the microwaves synthesized to have the phase difference of a quarter cycle can heat food in the cooking chamber 10.

In the meantime, the microwave range according to the present invention may include a microwave transmission grill arranged at the lower end in the cooking chamber. For instance, metal lines are densely arranged to be perpendicular to the linear polarized beams, reinforcing metal lines are arranged at an interval of a half of the wavelength of the microwaves in the cooking chamber in the direction of the polarized beams, the grill is arranged from the floor to the height corresponding to a quarter of the wavelength of the microwaves in the cooking chamber or is arranged as high as odd times of the wavelength. Because the electric force lines of the microwaves in the cooking chamber are formed in a uniform direction in parallel to each other, the microwave transmission grill can be used. The microwave transmission grill can provide uniform heating at upper and lower portions since microwaves are formed to the maximum even from the bottom surface of the food.

As described above, the present invention can cook food uniformly since microwaves are uniformly radiated from the upper part of the cooking chamber.

Furthermore, the two slot antennas of the paired slot antennas are arranged in such a way that the distance between the centers of the two slot antennas becomes a quarter of the wavelength of the microwaves in the waveguides and are arranged to intercross each other based on the central lines of the waveguides, thereby offsetting reflected waves in the waveguides.

Additionally, the present invention can radiate spatially uniform microwaves since microwaves are radiated into the cooking chamber by a plurality of the paired slot antennas, and can provide temporally uniform heating effect to food due to a phase difference of the microwaves radiated from the two slot antennas.

1. A radiation module of a microwave range comprising:
first and second waveguides disposed at an upper part of a cooking chamber to form parallel routes to guide microwaves of a magnetron; and
a plurality of paired slot antennas arranged on bottom surfaces of the first and second waveguides in a progress direction of the microwaves,
wherein each paired slot antenna includes two slot antennas,
wherein the two slot antennas have a first interval distance relative to the progress direction of the microwaves and are arranged to intercross each other in the opposite directions to each other based on central lines of the waveguides, and
wherein the first interval distance is a quarter of the wavelength of the microwaves in the waveguides.

2. The radiation module according to claim 1, wherein the first and second waveguides are horizontally spaced apart from each other at the upper part of the cooking chamber.

3. The radiation module according to claim 1, wherein the first and second waveguides are connected with each other integrally in an area where the magnetron is located, and form symmetric routes which split from the location of the magnetron and extend in the same direction.

4. The radiation module according to claim 1, wherein the two slot antennas of each paired slot antenna have long axes parallel to the central lines.

5. The radiation module according to claim 1, wherein each paired slot antenna includes two slot antennas of which a second interval distance relative to the central lines gets longer as the arrival order of the microwaves is later.

6. The radiation module according to claim 5, wherein the two slot antennas of each paired slot antenna have the same second interval distance relative to the central lines.

7. The radiation module according to claim 1, wherein the neighboring paired slot antennas are formed to be spaced apart from each other as far as a half of the wavelength of the microwaves in the waveguides.

8. The radiation module according to claim 1, wherein the two slot antennas of a plurality of the paired slot antennas are arranged in the first waveguide and the second waveguide to have the same pattern.

9. The radiation module according to claim 1, wherein the slot antennas arranged in the first waveguide and the second waveguide have a second interval distance relative to the central lines which gets longer as the arrival order of the microwaves is later.

10. A microwave range comprising:
a cooking chamber;
a magnetron for radiating microwaves through antennas; and
a radiation module for guiding the microwaves radiated from the antennas to an upper part of the cooking chamber,
wherein the radiation module includes:
first and second waveguides disposed at an upper part of a cooking chamber to form parallel routes to guide microwaves of a magnetron; and
a plurality of paired slot antennas arranged on bottom surfaces of the first and second waveguides in a progress direction of the microwaves,
wherein each paired slot antenna includes two slot antennas,
wherein the two slot antennas have a first interval distance relative to the progress direction of the microwaves and are arranged to intercross each other in the opposite directions to each other based on central lines of the waveguides, and
wherein the first interval distance is a quarter of the wavelength of the microwaves in the waveguides.

11. The microwave range according to claim 10, wherein the first and second waveguides are connected with each other integrally in an area where the magnetron is located, and form symmetric routes which split from the location of the magnetron in order to form symmetric routes which are spaced apart from each other and extend in the same direction horizontal to the upper part of the cooking chamber.

12. The microwave range according to claim 10, wherein each paired slot antenna includes two slot antennas of which a second interval distance relative to the central lines gets longer as the arrival order of the microwaves is later.

13. The microwave range according to claim 12, wherein the two slot antennas of each paired slot antenna have the same second interval distance relative to the central lines.

14. The microwave range according to claim 10, wherein the neighboring paired slot antennas are formed to be spaced apart from each other as far as a half of the wavelength of the microwaves in the waveguides.

15. The microwave range according to claim 10, wherein the two slot antennas of a plurality of the paired slot antennas are arranged in the first waveguide and the second waveguide to have the same pattern, and
wherein the slot antennas included in a plurality of the paired slot antennas arranged in the first waveguide and the second waveguide have a second interval distance relative to the central lines which gets longer as the arrival order of the microwaves is later.
